(19) United States
(12) Patent Application Publication
(10) Pub. No.: US 2005/0061630 A1
(43) Pub. Date: Mar. 24, 2005

(54) Device and system for conveying goods

(76) Inventors: Heinrich Lutz, Dirlewang (DE); Johann Lochbrunner, Neu-Ulm (DE); Hinrich Stave, Mindelheim (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/832,366

(22) Filed: Apr. 27, 2004

(30) Foreign Application Priority Data
Apr. 28, 2003 (DE) 103 19 121.6
Feb. 23, 2004 (DE) 20 2004 002 931.6
Aug. 21, 2003 (DE) 103 38 325.5

(51) Int. Cl. B65G 39/18; B65G 13/02

(52) U.S. Cl. 198/789

(57) ABSTRACT

The invention refers to a device for conveying goods as well as a conveying system for goods. The good runs on a conveying belt. The good has running treads, which are supported on the edges. The running treads are inclined.

The invention refers to a device for conveying goods, the device having two roller conveyors arranged side by side, on which the good, which has to be conveyed, is supported. The invention also refers to a system for conveying goods, for example work pieces or pallets carrying work pieces. The good runs here on a conveyor belt, and the good has at least two running treads. The conveyor belt itself has at least one row of wheels, and the running tread of the good runs on the wheels.

### BACKGROUND OF THE INVENTION

Devices as described above for conveying goods are sufficiently known. The goods, for example work pieces mounted on pallets or the like, are conveyed by means of the device from one machine tool to another. Drives for the device are provided here in order to make the rollers rotate and thus reach a conveying of the supported good. Also devices are known where two roller conveyors arranged side by side are used. They are used, for example, when the good, in particular suspended, has to be conveyed between the roller conveyors.

Known devices in this field have a drive on each side in order to guarantee that the good on the conveyor belt is driven evenly.

This second drive for the roller conveyor is accordingly expensive.

The conveying systems described in the beginning are used for example for conveying goods in a wide technical field. For example, roller conveyors are known, on the surfaces of which the goods are carried and a rotation of these rollers conveys the good. Other known conveyor belts comprise two supporting profiles, and two wheels or rollers with a distance are driven on a common shaft, the good being supported on the rollers. Conveniently the good, for example the pallet, has here on its bottom side a suitable running tread which interacts with the respective wheel. The wheels take over the weight of the good.

The conveying should be carried out as reliably and efficiently as possible. Therefore it has to be made sure that the good is guided safely and the conveying is not too energy consuming. In order to make sure the good remains on the conveyor belt, for example, lateral stoppers are known. The good runs against these stoppers and is thus kept on the conveyor belt. It is a disadvantage here that friction occurs by means of that, that means the efficiency decreases. There is also the risk that the good jams on the lateral rails and a conveying is impossible altogether.

A drive for roller conveyors of the before mentioned kind is, for example, known. It is suggested that in particular in bending sections of the conveying line a flexible shaft is connected to the straight main drive shaft. For balancing the differences in speed, especially in the bent regions, the running rollers have various diameters. The device is technically very complicated and designed expensively.

Furthermore a solution is known which shows inclined arranged running rollers, these running rollers, however, being arranged in roller bearings in such a way that they are guided angled to the conveying plane. There is no lateral guiding here, and the arrangement in the roller bearings is also designed quite expensively.

It is an object of the invention to present a device and a system as described above where the production effort is clearly smaller and the running of the good is improved.

### BRIEF SUMMARY OF THE INVENTION

This problem is solved by the fact that, coming from a device for conveying goods, as described in the beginning, only one roller conveyor, at least for a part of these rollers, has a drive.

It is not necessarily provided that all rollers of the roller conveyor are driven. Sometimes it is indeed sufficient if several not-driven rollers are provided for supporting the good, which then are set rotating by the movement of the good.

The possibility for saving is considerable. The second roller conveyor needs only to be supported, but not equipped with a drive.

In a variant of the invention it is provided that the roller conveyor is arranged in a frame, and the roller of the roller conveyor is supported in the frame. In this arrangement a design without a free collar of the roller is realised. For example, on the left and the right hand side of the roller a suitable bearing for the roller shaft is arranged, and the good is conveyed substantially via the roller.

Alternatively to that it is possible that the roller projects on the frame with a free collar on one side, and the roller shaft is supported in the frame.

The roller shaft is supported on the one side in the frame and carries on its other, free end a roller. The design is suitable to convey either the good above it or, on the other hand, to arrange the good during conveying also between the two roller conveyors.

In a preferred variant of the invention it is provided that the rollers of the roller conveyor serve for guiding the good. In known arrangements the rollers are, for example, designed as cylindrical bodies. For guiding the goods on the conveying device separate guide rails and so on are provided. The roller conveyors according to the state of the art serve only for driving the conveyed good. In these arrangements it was inevitably necessary that both roller conveyors had a drive which on top of that had to be synchronised exactly in order to avoid that the conveyed good, because of differently rotating rollers, starts rotating on the roller conveyor or interlocking.

By means of a clever design, that means the rollers of the roller conveyor serve for guiding the good, a secure conveying of the good is achieved.

Surprisingly it has been recognised there that by means of that even a rotating or interlocking of the good on the conveying device can be avoided. It has been recognised here that it is basically sufficient if at least one roller conveyor exercises an according guiding task in order to produce a safe, failure-free conveying of the good. In an one-sided arrangement it is favourable if the driven side performs this guide through the roller. This effect, however, also occurs if the guide is performed by the not-driven side. In a common design naturally also the guide is improved. The development according to the invention guarantees that the good is guided in the direction of the shafts. The separate application of guide rails is not necessary here.

In a preferred variant of the invention it is provided here that the roller has at least on one side a flange with a sidewall facing the good, against which the good, respectively a part of the good, can run.

For guiding the good by the rollers several variants are provided. This can be reached, for example, by means of the mentioned embodiment with the help of a flange on the roller. The flange here has the characteristics of a tread of wheels. When the good, for example the pallet, runs against the flange (the good is dislocated in the direction of the roller shaft) this movement is impeded by the flange and the good is guided.

A similar effect is reached in a further alternative of the invention which provides that the roller has V- or U-shaped inclined running treads. The good which has to be conveyed has here a suitable conveying rail which interacts with the running tread. For the case that a V- or U-shaped inclined running tread is provided, as a rule, two running treads arranged angled to each other are provided, and opposing forces occur which contribute to a guiding of the good. In the U-shaped running tread the flanks may also be slightly inclined, respectively in the bottom region of the limb the web can also serve as running tread, or not. The invention is, concerning this case, variable.

Furthermore, in another alternative, it is provided that the running treads are designed even and/or crowned. This is also based on the same idea, namely that the inclined contact surface results, because of the distribution of powers of the weight, in a power component rectangular to the weight, which can be used in a suitable embodiment for a guiding of the good. In the case that the running tread is inclined, that is orientated not rectangular to the weight, it is convenient that the other roller conveyor has an arrangement without center plane, symmetric to it, supporting the good on two differently orientated running treads.

There is even another possibility how the roller serves for guiding the good. In another variant according to the invention it is provided that the roller has a circumferential groove with sidewalls against which the good, respectively a part of the good, can run. In this variant it is provided that the good, respectively the conveying rail of the good, is supported on a supporting surface orientated essentially horizontally, respectively parallel, to the roller shaft, the supporting surface being designed cylinder-like. Depending on the forces acting on the good a dislocation is carried out in the direction of the roller shaft which is limited by the sidewalls.

Advantageously the circumferential groove is here designed essentially U-shaped, however, other embodiments are also possible.

As a variant it is provided that the bottom of the groove of the circumferential groove forms the running tread for the good, respectively the pallet carrying the good. This may be supported additionally by a running tread region near the sidewall.

However, it is convenient when the sidewall is bevelled with regard to the bottom of the groove and the circumferential groove, respectively the flange. In such a situation the sidewall co-supports like a running tread only when the good runs against something. Usually in a U-shaped circumferential groove the sidewall is orientated rectangular to the bottom of the groove or radial with regard to the roller shaft. This groove-like guide already leads to a satisfactory guide of the good. However, the guiding effect is improved by the bevelled sidewall, that means it forms a sharp angle with the bottom of the groove, respectively the roller shaft. In the case that the good runs against the sidewall it shows that the transmittable driving force increases considerably because of the resulting triangle of forces in the region of the sidewall. The normal force acting on the supporting surface of the sidewall is considerably larger than the weight acting here and it improves the transmission of forces of the transport power. Additionally another power component occurs by means of which the good, respectively the rail is pushed away from the sidewall. It is significant here that this effect does not only occur on the driven side but naturally also on the not-driven side, producing the guiding effect. It is convenient to select an arrangement where opposing forces cause a stabilisation, that means, for example, surfaces which are inclined toward each other and so on.

In a variant of the invention it is provided that the sidewall itself is angled. That means that the sidewall is sub-sectioned in two or more sections which have the differing inclination with regard to the bottom of the groove, respectively the roller shaft. By means of that it is possible to achieve the effect described above accordingly, that means, for example, when the good threatens to jump out of the roller, to strengthen the restoring effect by a region which is angled in another way. The angulation causes truncated cones with different cone angles.

In another variant of the invention it is provided that the bottom of the groove is wider than the conveying rail of the good supported in the bottom of the groove. Certain inaccuracies, for example in the orientation of the line, can be compensated by this.

In another variant of the invention it is provided that the running tread of the roller is designed essentially horizontally orientated, inclined, groove-like or projecting V-like. The invention is in no way limited to an exact embodiment of the running tread. It has been recognised that by the special design of the running tread of the rollers the guiding effect for the good on the roller conveyor is improved in a similar way.

According to the invention it is also possible that, for example, side surfaces, which usually do not serve as running treads, then take over tasks of running treads when, for example, the good accordingly runs against the side surfaces and then these side surfaces are also inclined, in order to exercise a corresponding guiding force and advance force on the good. The arrangement leads to a self-adjustment. The good rising on the inclined side surface gets a better drive on the inclined surface, as the normal component is larger. Because here a larger drive force is available, twisting of the good because of the roller conveyor, which itself is not driven, is compensated in such a way that the good is straightened on the line and does not interlock. Of course, this effect also occurs on the driven side. The effect occurs here with cylinder-like as well as cone- or double cone-like running treads. Basically already one or two diagonal (=cone-like) side surfaces on the rollers of a roller conveyor are enough.

Furthermore it is provided that the rollers of the driven roller conveyor and the rollers of the not-driven roller conveyor are designed similarly. Similar means here that the rollers of the driven and the not-driven roller conveyor contribute in the same way for guiding the good. The actual design of the rollers may differ here, and it may be convenient that they are actually identical, therefore allowing a universal use of the pallet.

The effect is to provide a failure-free conveying device on which the good can be conveyed reliably.

In another aspect of the invention, which is, if necessary, also expressly part of an independent application, that means not referred to the main idea of the before mentioned field, a conveying device is suggested where the frame is designed like a housing, in particular with a housing lid sealing the housing. It is provided here that the housing is produced, for example, in an aluminum extrusion process, making the production convenient. It is clever here to provide on the housing corresponding projections or noses through which a lid can be fastened without fastening material, like screws and so on. For that purpose, for example, suitable clip connections are used where corresponding projections are pressed in undercuts or snap-ins. For maintaining the housing lid can be dismantled simply and fast.

It is provided here that the housing holds the shaft drive of the roller shaft. As shaft drive here, for example, a gear wheel chain drive, an electric drive, a bevel gear drive or the like is used. The advantage of the embodiment of the housing according to the invention is the fact that optionally even various types of shaft drives can be built in the housing. Therefore the using can be used in multiple ways and can be produced at large numbers at low costs.

Furthermore the invention refers to a good, in particular a pallet, which has conveying rails which are supported on the running tread of a roller of a good conveying device. For an optimum conveying the interaction of the good with the conveying device has to be taken into consideration. This leads to a particular design of the good as the complete conveying device has to be seen as a system and the effort altogether has to be reduced here accordingly. By means of the object according to the invention the costs are already lowered considerably and the special design of the good contributes to the failure-free operation of the arrangement. As far as in this connection a special design of the good, also in connection with other characteristics, is referred to, this has to be, at this point, expressly described and understood even for the good as independent subject matter.

In a preferred variant it is provided that at least one lateral edge of the conveying rail is bevelled or chamfered. In a variant of the invention it is provided that the bottom side of the conveying rail is supported on the, for example cylinder-like, running tread of the roller. However, in the case that the guide of the roller sets in, that means the good has to be orientated and guided correspondingly on the device, it happens that even other regions of the conveying rail interact with the roller, respectively parts of the roller.

Here a bevelling favours the guide effect, in particular when the bevelling is chosen in such a way as it is designed on the roller. The result is an optimum power transmission. However, simultaneously the bevelling, respectively the chamfering, achieves that there are no sharp edges which could possibly damage the roller or wear it out more then necessary.

In another embodiment of the invention it is provided that besides the conveying rail a groove is arranged on the good, the width of which is chosen in such a way that only the side provided on the conveying rail and limiting the groove can interact with the rollers. The dimensions are selected in such a way that indeed only the conveying rail on the bottom side of the good, respectively the pallet, interacts with the respective side walls of the roller. Conveniently here the conveying rail is produced by milling a groove on the bottom side of the good, respectively the pallet, the dimensions being selected in such a way that it is guaranteed that only the side provided on the conveying rail limiting the groove interacts with the rollers. This leads to a good control of the complete system and failures which may lead to an undesired rising of the pallet on the conveying device are avoided reliably.

Furthermore the invention claims protection for a special conveying system where the problem according to the invention described in the beginning is also solved. In the conveying system the advantageous interaction of the device for conveying goods, as described, with a good, which is in particular designed as described, is protected. The arrangement achieves a considerable reduction of the manufacturing costs as the drive is simpler, thus more cost effective, however, reliable and effective. Here not primarily the exactly claimed embodiment of the good in the conveying system is significant, the interaction with the good improves the performance of the invention altogether.

In order to solve the described problem the invention proposes also a system for conveying goods as described in the beginning where the running treads of the good are inclined or designed spherically.

Eventually the solution according to the invention provides that the good runs along two differently inclined or spherically designed running treads. Depending on the angle of inclination towards the vertical line the weight acting in the vertical line is divided into a normal force, which is vertically on the supporting surface and a horizontal force. The horizontal forces which occur on both running treads are opposing and thus form a system stabilising itself. In the end this leads to a better centralising of the good. As a result through the suggestion according to the invention the arrangement of lateral guide rails and so on is not necessary as in addition to that the system avoids that the good rises on the flanks of the wheel or jams otherwise. A balance is obtained here, the good is guided by the diagonal, respectively spherically inclined, running treads reliably, for example groove-like and so on.

The effect according to the invention does not only occur in running treads with an inclined plane (against the vertical line). The same effect, for example, is reached with spherically designed running treads. The characteristic of the spherical running treads is the tangent which is inclined on the running tread in the contact point with the wheel, like in an inclined plane as running tread. As spherical running treads for example cylinder surfaces, surfaces of ellipsoids and the like are seen. There are a variety of geometric bodies which show the effect according to the invention.

In addition to the clear improvements of the centralising of the good during running there is, however, the surprising advantage that by means of the angle of the inclined running tread the normal force between the wheel and the running tread is increased and can be transmitted through higher driving forces frictional engaged. However, if higher driving forces can be successfully transmitted the goods can be moved faster, because they can be accelerated faster. The invention here presents the chance to adjust the height of the driving forces which have to be transmitted by means of the selection of the inclination of the running treads. As an increasing of the driving forces should usually only be carried out together with an increasing of the coefficient of friction, that means rubber wheels or the like, this can be realised by the suggestion according to the invention in the same way without using elements which are prone to wear.

Therefore the invention achieves a better use of energy (reduced friction), better guide of the good and a faster conveying of the good.

In a preferred variant of the invention it is provided that a conveying rail of the good is supported on the groove bottom of a roller equipped with a circumferential groove. This embodiment achieves that the conveying rail conveys the good by means of the sidewalls of the circumferential groove of the roller by guiding the good.

As far as in this connection the advantageous interaction of the good with the conveying device is mentioned, this is naturally also a subject matter of the conveying system which is claimed. The applicant reserves the right to include in the frame of the conveying system all characteristics of this application also in the subject matter of the patent.

Advantageously the arrangement of the invention is chosen in such a way that the planes comprising the running treads intersect one another.

The good has two running treads. The running treads are, according to a variant of the invention, an inclined plane. Alternatively, the running treads are according to the invention also crowned, in such a way that the tangent planes (where the wheels have contact) are inclined. These planes intersect one another. This is the consequence of the opposing horizontal forces, as described above. In the sense of the invention this goes also for spherically designed running treads. The plane is defined here as follows. The wheel is supported in a point on the running tread. With regard to this support point the tangent line to the spherically designed running treads has to be formed. This tangent line is part of the pre-described plane. It has to be taken into consideration that with a spherical running tread these planes are variable, thus a bundle of planes is formed. The characteristic of these planes is the fact that their angle of inclination varies. Therefore it is possible to adjust the height of the driving forces, which can be varied at a maximum, and which depend on the angle of inclination. It is, for example, an advantage to select in the starting region of the pallet another inclination, respectively shape of the groove, as in the region where the good is conveyed with constant speed. This is achieved by different wheel gauges of the wheel rows which act then on the different contact surfaces—and resulting from that—differently inclined planes of the running treads.

According to the invention it is provided that the planes intersect one another in a region between the rows of wheels. Conveniently the planes intersect one another in the center plane which can be thought between the rows of wheels. However, the invention is not limited to that. It is possible here that the planes intersect one another either above or below the good. Accordingly it is possible that a “groove-like” or a “saddle-like” guide is formed.

According to the invention there are several variants which interact with the inclined, spherically designed or groove-like formed, running tread of the good with the wheels. In a first variant, for example, it is provided that the rotational axis of the wheels is inclined. This leads to a corresponding inclination also of the drive shaft of the wheels. A central drive is preferred, for example a friction drive, which is used for the wheels. A first drive shaft here provides a number of wheels with the necessary turning moment. By means of the inclined arrangement of the drive shaft of the wheels the common drive of a number of wheels can be shifted upwards in a space-saving way. Such an arrangement is, for example, an advantage in the working area of machine tools, as just in this region a high machining possibility by the spindle should not be hindered by elements of the conveying drive.

The development according to the invention of an inclined rotational axis of the wheels thus has even further advantages for the use of the conveying system according to the invention.

In another variant of the invention it is provided that the wheels of the two rows have a common axle and/or a common shaft and/or are arranged parallel to each other. In this case according to the invention the rotational axis forms an angle with the plane of the running tread. In this variant of the invention it is an advantage if the wheel is designed cone-like, respectively truncated cone-like, and the wheel surface which actually interacts with the running tread of the good has the corresponding inclination.

In the other case, where the rotational axis of the wheels is inclined, the wheels may also be designed cylinder-like.

Basically it is possible that, independent from the orientation of the rotational axes with regard to the running tread, each shape of wheels can be used. The invention is not limited here.

Thus it is, for example, provided in a variant of the invention that the wheel is formed like a cylinder. In another variant it is provided that the wheel surface which runs on the running tread, is designed crowned. By means of this embodiment it is achieved that the wheel is supported only in the ideal case along a line on the surface, and therefore increased wear, for example through different circumferential speeds of the wheel and resulting relative speeds on the running tread, do not exist. Alternatively this is also achieved by a crowned design of the running tread of the good.

Furthermore it is, of course, possible that the wheel is designed like a cone, respectively a truncated cone.

In another preferred embodiment of the invention it is suggested that the wheel surfaces are designed groove-like, essentially U-shaped, V-shaped or wedge-like. Here, for example, the limbs of the U-shaped wheel surfaces are slightly inclined. On this limb surfaces the wheel runs on the running treads of the good. However, the web of the U connecting the limbs may also, in another variant, be inclined. This variant of the invention leads to other surprising advantages. It allows the wheel to have several differently inclined wheel surfaces and at least two of this wheel surfaces to interact with the running treads of the good. It is not significant here anymore that two wheels hold the surfaces inclined towards the other, but the running treads are, for example, located on one side of the good and engage in the different wheel surfaces of one and the same wheel of a wheel row. By means of that it is, for example, achieved that the pallet, respectively the good, is also conveyed vertically orientated and the running treads are then on one side of the good.

According to the invention it is suggested here that the wheel has several differently inclined wheel surfaces, and at least two wheel surfaces of the wheel interact with the running tread of the good. For that purpose there are two basic variants. In the first variant the wheel has a groove-like designed wheel surface, or the wheel surface is designed wedge-like or double truncated cone-like. Of course, these particular wheel surfaces themselves may be designed crowned in order to guarantee a low-wear operation.

Even if the invention results already in a very good centralisation of the good, which has to be conveyed, it is, in another variant of the invention, an advantage if a wheel flange is provided in the wheel. However, the wheel flange also allows an interaction with conveying switches and therefore realisation of a control of the good along the conveying path.

The drive of the good is carried out via the drive of the wheel rows. The wheel rows, each of them having, for example, autonomous drives, are only synchronised to each other by their electronic. However, alternatively it is also possible to provide a central drive which acts on both rows of wheels and thus drives both rows of wheels with the same speed. As far as the wheels of both rows of wheels are arranged on a common rotational axis the possibility exists to provide a central drive shaft only on one side of the wheels, and to transmit the turning moment for the other row of wheels by the continuing rotational shaft. Also by means of that a synchronised run can be realised.

In a preferred embodiment of the invention it is provided that several rows of wheels have a common or several drive(s). By means of the arrangement of several drives they can be, among each other, dimensioned a bit smaller because the drive performance can be taken from several drives. A common drive, for example, is synchronised automatically by a mechanical coupling, for example a common drive shaft. As drive motors, for example, electric motors can be used.

Furthermore it is an advantage that the wheel can be swivelled around an axis which is vertical to the rotational axis of the wheel. The wheel in this arrangement can be altered. It is possible to swivel the wheel slightly so that, if for example a corresponding movement is carried out around this rotational axis, the wheel is disengaged to the running tread. Advantageously here the wheel is turned around an axis which is rectangular to the rotational axis of the wheel.

The invention does not only extend to the conveying system as described, but it also claims in the same way a good according to the invention, in particular a pallet which has running treads which interact with wheels for conveying purposes, the running treads being designed inclined or spherically. Especially the use of such a good according to the invention in the conveying system described above leads to the advantages described there extensively.

In an advantageous development of the invention it is suggested that the good, in particular the pallet, is chamfered in the region of the running treads and the chamfer forms a running tread. The edge region of the pallet is formed like a spring or a wedge. It already has an inclined running tread. The development according to the invention provides that the edge region of the pallet is chamfered, and the chamfer gained in this way is used additionally as running tread. A pallet of such a design co-operates optimally with wheels, the wheel surfaces of which are designed like a groove and thus form several inclined regions of wheel surfaces which interact with the running treads of one side. The advantage of this design is in particular the fact that a pallet of such a design cannot only preferably be conveyed upright, that means the rows of running wheels are arranged one above the other, but such a pallet can equally be used horizontally. Even designs are possible where the rows of wheels are preferably arranged horizontally side by side, and then only one running tread is used per side of the good.

Furthermore it suggested in a variant according to the invention that the good, in particular the pallet, is chamfered in the region of the running tread, and the chamfer forms the running tread, and these regions of the running tread interact either with groove-like, essentially U-shaped or V-shaped designed wheel surfaces, or cylinder-like or truncated cone-like wheels, arranged alternating, interact with the two adjoining regions of the running treads of the good. The first variant of this development according to the invention will be described with more details in FIG. 7. The other variant has the aim that alternating, however, at least arranged on both sides in such a way that it supports the pallet, respectively the good, simple wheels are arranged which prevent chips from collecting in the groove-like channel, which otherwise would cause a lifting of the pallet. The even planes of the wheels, whether they are cylinder-like or truncated cone-like, prevent a deposit and collecting of chips. This may be an advantage, for example, in machining centers, on the other hand, the groove-like wheel arrangements may be an advantage for example in measuring stations where there is no cutting machining.

An arrangement of the invention designed in such a way increases the use considerably. The pallet as well as the complete system according to the invention becomes considerably more flexible.

Furthermore the invention extends to the use of a wheel which is actually known itself, which is used in a row of wheels for forming a conveying path or conveying belt, the inclined running tread of a good which has to be conveyed running on the wheel.

One aspect of the invention is especially the advantageous adjustment of the individual elements of the conveying system to each other in order to achieve the results described before. However, the range of protection extends in the same way to the good designed according to the invention as well as to the use of a wheel according to the invention in a corresponding conveying system.

### BRIEF DESCRIPTION OF THE SEVERAL VIEWS OF THE DRAWINGS

The invention is shown schematically in the drawings.

In the figures:

FIG. 1 a view of the device according to the invention,

FIG. 2, FIG. 3 each a view of a detail of the invention,

FIG. 4, FIG. 5 in an enlarged detail the interaction of the good on the roller according to the invention,

FIG. 6, 7, 8 various variants of the conveying system according to the invention,

FIG. 9a,b,c,d,e,f and various variants of the wheel FIG. 11a,b,c,d according to the invention,

FIG. 10 another detail of the invention in a top view and

FIG. 11 another variant of the invention.

### DETAILED DESCRIPTION OF THE PREFERRED EMBODIMENTS

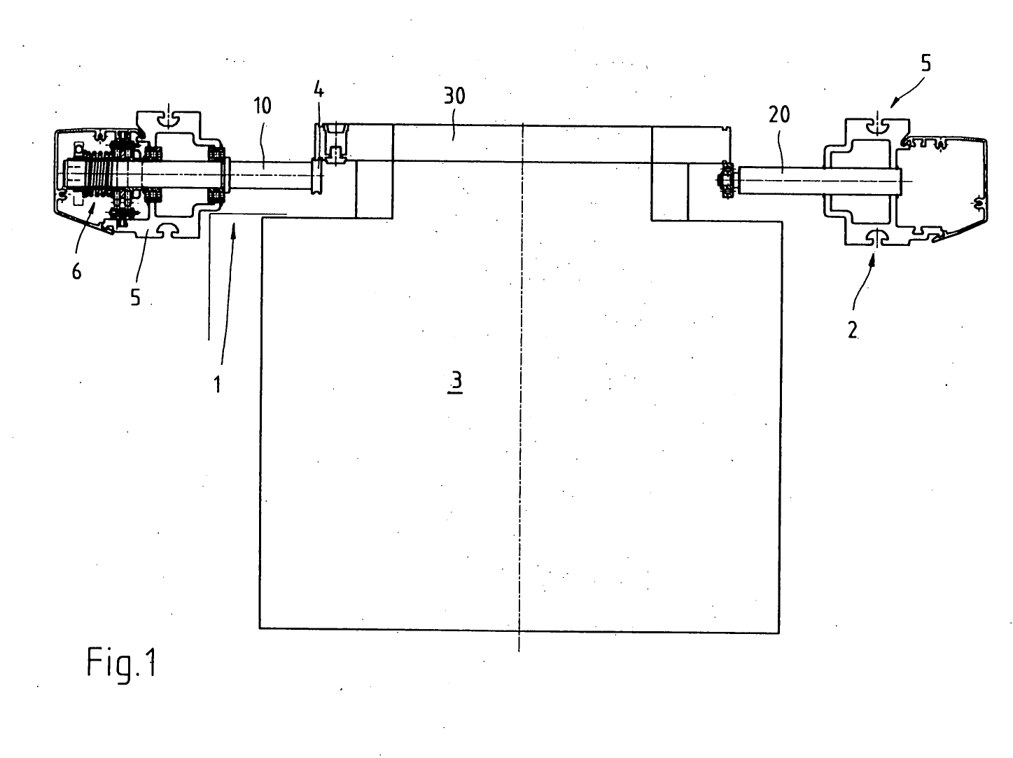

In FIG. 1 the arrangement is shown schematically in a general view. A first roller conveyor 1 is arranged on the left hand side, a second roller conveyor 2 is arranged on the right hand side of the good 3. The good 3 is for example a work piece which has to be conveyed by the device according to the invention to various machining stations. Conveniently it is provided here that the good 3 is clamped on a pallet 30. However, it is not decisive for the invention whether the good 3 is supported directly on the roller conveyors 1, 2, or a pallet 30 carrying the good, as in this case, has to be seen as good.

The roller conveyors 1, 2 are formed by the roller shafts 10, 20 which carry on each of their ends facing each other a roller 4. It is clear that in the view chosen here a number of roller shafts arranged one behind the other are provided. Thus they form the roller conveyor. The roller shafts 10, 20 are supported each in a frame 5 and corresponding bearings are provided for that purpose.

It can be seen clearly that on the left roller conveyor 1 a drive 6 for the roller shaft 10 is provided, however, the right roller conveyor 2 shows only a supported roller shaft 20 without drive. This is the point of the invention, it is now possible to do without the necessary additional effort on the second roller conveyor 2.

Another part aspect of the invention, for which, as already described, also independent protection is claimed, is the particular design of the housing 50 which serves as frame 5 for holding and bearing the roller shafts 10, 20.

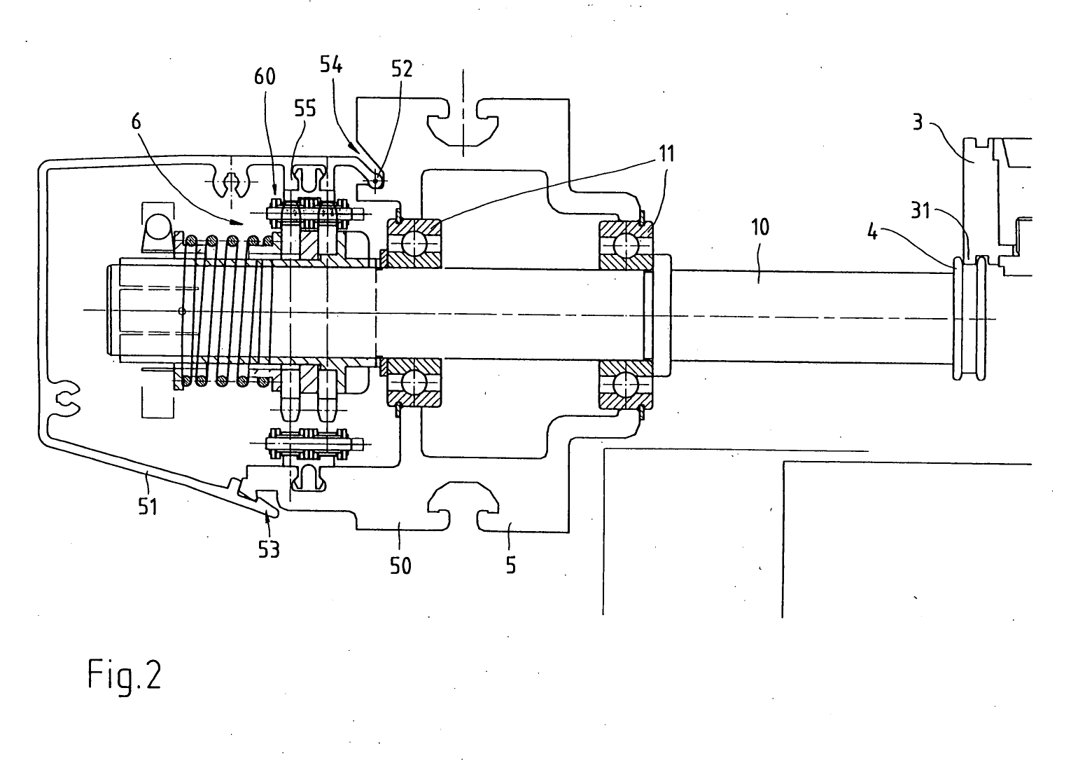

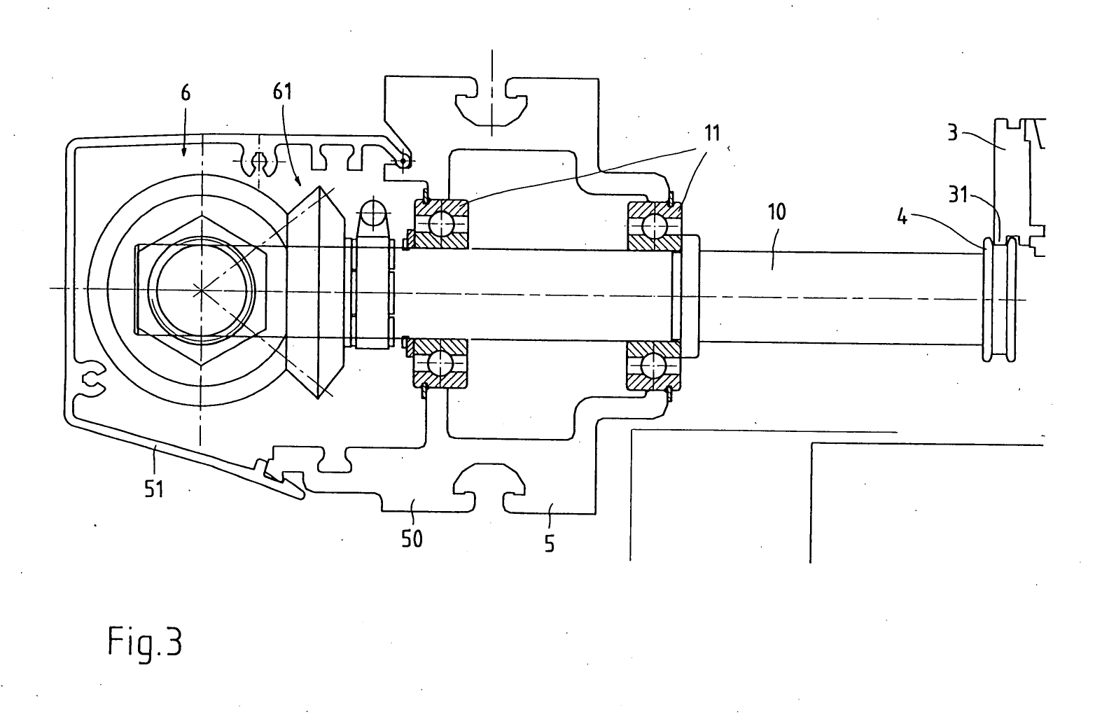

In the housing 50 in the right hand part (see FIG. 2) two bearings 11 are provided for the support of the roller shaft 10. The drive 6 is arranged on the side opposite the roller 4; in FIG. 2 this is a chain drive, in FIG. 3 a bevel gear drive. The advantage of the invention is here that the housing 5 can be constructed universally, however, at the same time small and space saving, so that any drive 6 can be put there.

Advantageous here is also the embodiment of the housing lid 51, which seals the housing 50 on the left hand, respectively the outer, side. The lid 51 comprises here the end of the shaft on the side of the drive as well as the drive. Their housing lid 51 can be turned around a folding joint 52 and can be closed fixedly by the snap 53. The arrangement is cleverly chosen in such a way that the housing lid 51 can be opened and removed without any tools. Only the snap 53 has to be released and then the lid can be swivelled around the folding joint 52 upwards, respectively it can also be removed out of the pocket-like recess 54.

Advantageously the housing lid 51 is manufactured of aluminum and, for example, produced in an extrusion process; that makes it possible to provide corresponding screw channels or other holding brackets, as it is, for example, indicated for a holding-down clamp with the clip connection 55. The clip connection 55 has on both sides an undercut into which a corresponding spring counterpart can be pushed in and is thus held.

Another very important point of the invention is the arrangement of the roller 4 interacting with the good 3.

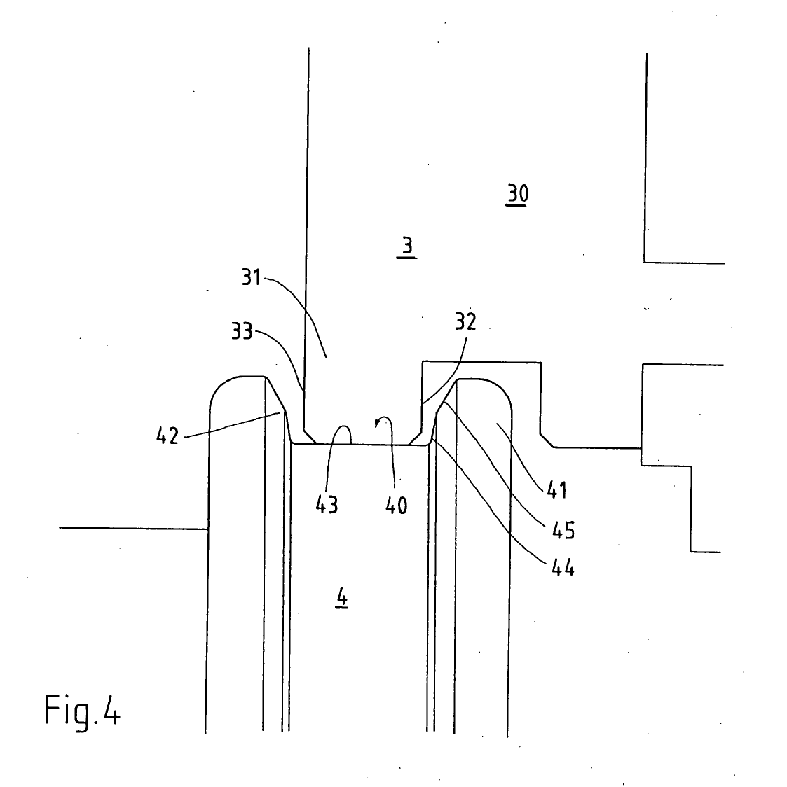

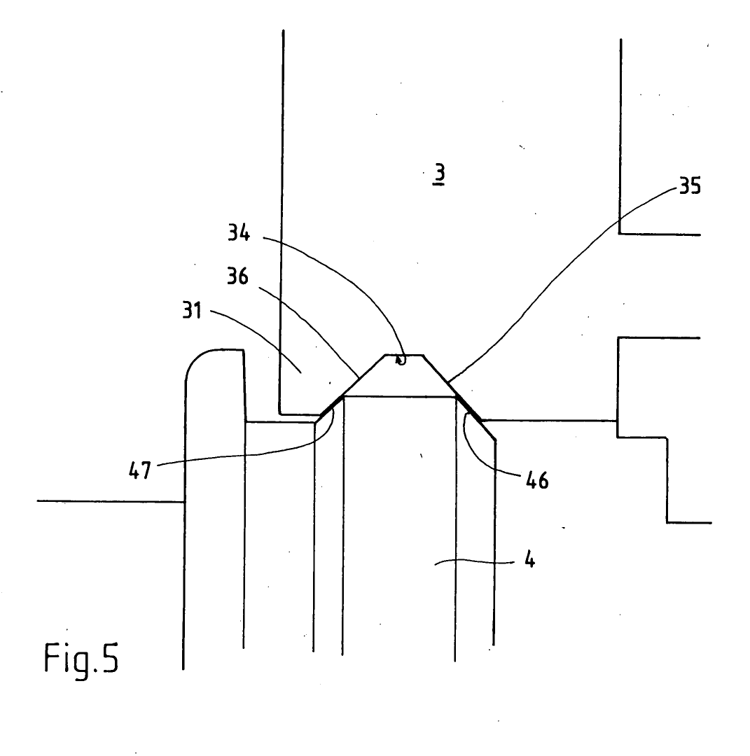

The design shown in FIG. 4 is an example how the roller 4 of the roller conveyors 1, 2 serves for guiding the good 3, making the use of separate guide rails unnecessary.

The roller 4 is equipped with a circumferential groove 40. The circumferential groove 40 is here essentially designed U-shaped and is limited on the left and right hand side by the sidewalls 41, 42. The circumferential groove 40 is here designed essentially U-shaped, the side flanks of the U not being arranged rectangular above the bottom 43 of the groove, but form a sharp angle.

The bottom 43 of the groove serves in this example as running tread for the conveying rail; the running tread is, in this example, the surface of a cylinder.

It is shown that the conveying device according to the invention has a drive only on one side. In order to make sure that an interlocking or jamming of the good on the conveying device does not occur, in a development of the invention it is provided that the rollers of the roller conveyor serve for guiding the good. For that purpose, on the one hand, at least the rollers of one roller conveyor are provided, however, the rollers of both roller conveyors can be used for that purpose. It has to be taken into consideration here that by the movement of the good 3 a turning moment is transmitted to the not-driven roller conveyor 2. The roller shafts 20 are set rotating by the movement of the good 3. As it can be seen, for example in FIG. 1, a similar design of the good 3, respectively the pallet 30, on the one hand, and of the roller 4, on the other hand, is chosen there. A guide of the good 3 on the roller 4 is therefore carried out by the interaction of the sides 32, 33 with the sidewalls 41, 42. The inclined design of the side walls 41, 42 is an advantage as a normal force acts on these inclined surfaces which leads to a horizontal movement of the good, away from the respective inclined side wall 41, 42. It is significant here that this effect occurs on the not-driven side, that means that even the actually passively rotating region co-acts for the guide of the good on the guide line.

It is shown that the sidewalls 41, 42 are sub-divided into two regions 44, 45 which differ with regard to the angle of the inclination. The first bottom region 44 facing the bottom 43 of the groove is steeper, for example between 50° and 85°, the second region 45 which is located more on the top, away from the bottom 43 of the groove is more even, for example between 35° and 75°. By means of that it is possible to use the normal force correspondingly positively and to make sure that the good is not unguided.

In FIG. 5 another variant is shown. In contrast to FIG. 4 where only one conveying rail 31 is provided which interacts with the region of the running tread of the roller 4, that means the bottom 43 of the groove, in the embodiment according to FIG. 5 this is double.

The roller 4 according to FIG. 5 has two lateral flanks 46, 47, for example bevelled at 45°, which would intersect one another in the top region in an extension. The inclination angle with regard to the horizontal line, respectively with regard to the roller shaft, can be varied here in a wide range, for example between 20° and 80°, preferably between 35° and 65°. Good results have been reached in the region of 45°.

The good 3 has on its bottom side a corresponding “U”-shaped groove 34 in order to form in its left and right hand region a diagonally extending conveying rail 31. For that purpose the sidewalls 35, 36 of the groove 34 are orientated diagonally, namely in the same angle as the diagonally orientated roller regions 46, 47, which form running treads.

In a variant of the invention it is provided that these running regions are not cone surfaces, respectively truncated cone surfaces, but they are also designed crowned. In this connection here it is referred explicitly and comprehensively to the special embodiments of possible wheels to the German patent application 103 38 325.5.

It is evident that even this embodiment leads to a guide of the good 3 on the roller 4.

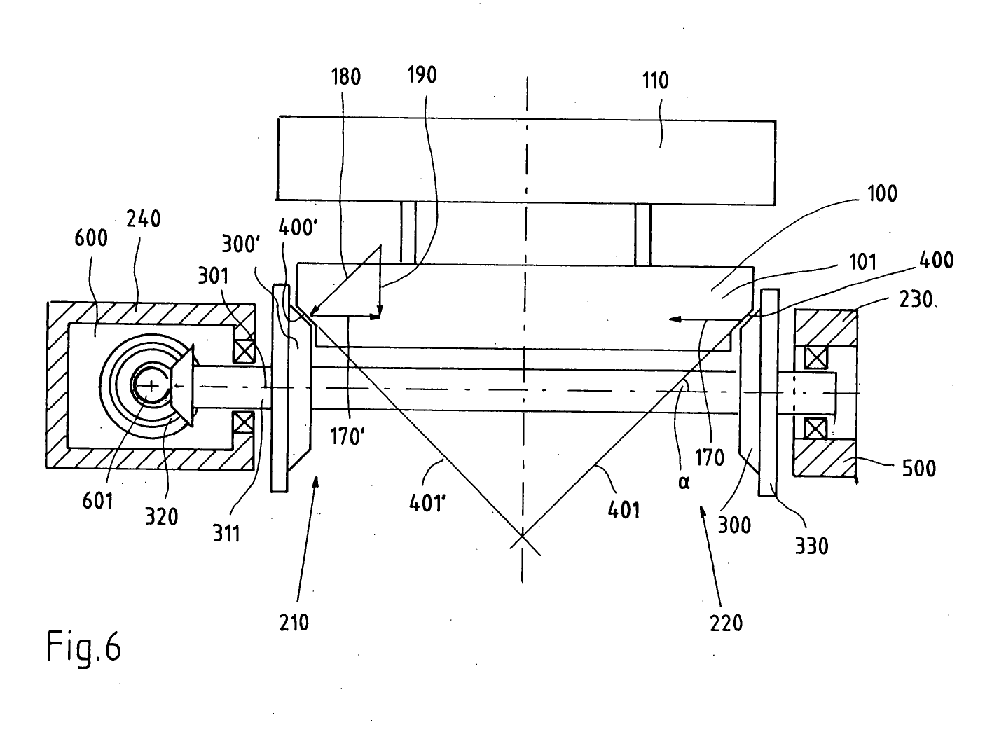

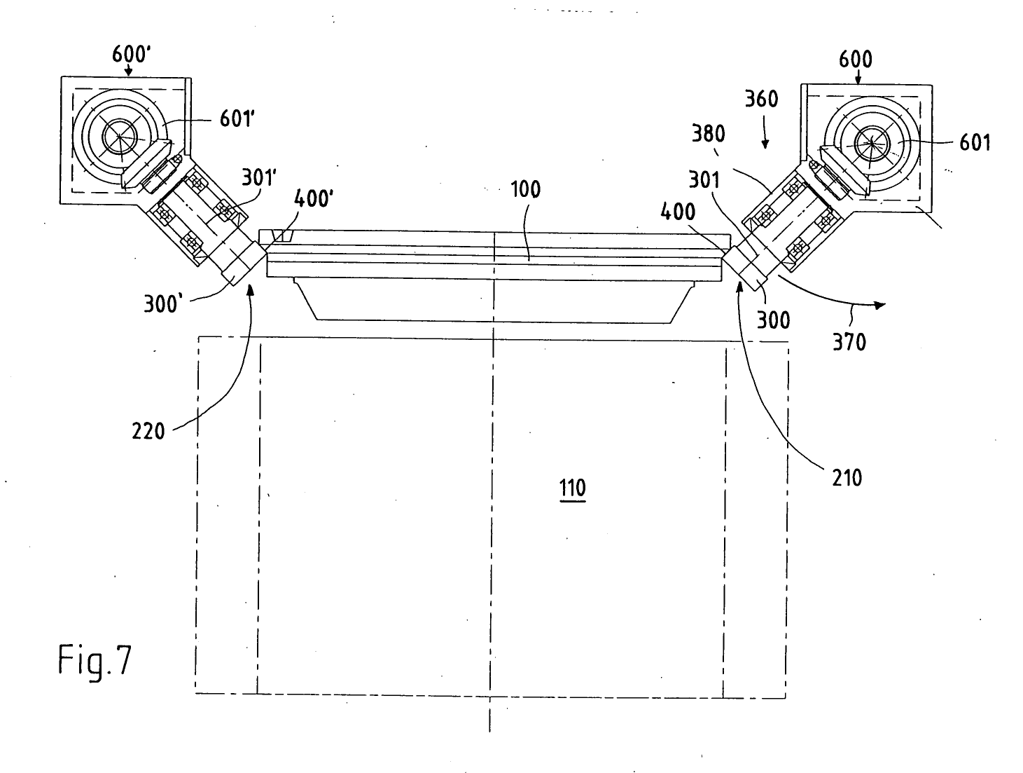

The system according to the invention is shown, for example, in FIG. 6. 200 shows a conveying belt which has two rows 210, 220 of wheels. In the selected view only one of the wheels of the two rows 210, 220 of wheels can be seen. The conveying belt 200 has a frame which is not shown in detail to which the supporting profiles 230, 240 are attached, and the supporting profiles 230, 240 carry the rows 210, 220 of wheels.

The supporting profiles 500, 230, 240 themselves have bearings in order to support the wheel shaft 311. In the example shown here the wheel shaft 311 drives the left hand wheel 300′ as well as the right hand wheel 300.

The drive 600 is used for driving the wheels 300, 300′. The drive 600 is formed by a drive shaft 601 extending vertically to the paper plane, where a rotation drive, which is not shown in detail, for example a gear motor or the like, is arranged.

The drive 600 is designed here as central drive and drives a number of wheels 300, 300′. The end of the wheel shaft 311, which is on the side of the drive, has, for that purpose, a bevel wheel which also takes, if necessary even by means of a friction coupling, the turning moment from the drive shaft 601. In the example shown here the rotational axis 301 is orientated essentially horizontally.

The conveying belt 200 serves for conveying goods 100. In the example shown here a pallet 101 is provided as good 100 on which a work piece 110 is clamped on.

The good 100 here is located above the wheels 300, 300′. The running treads 400, 400′ provided on the bottom surface of the good 100, here the pallet 101, are supported on the wheels 300, 300′.

According to the invention it is proposed that the running tread 400 of the pallet 101 usually does not extend horizontally, but the running tread 400 is designed inclined. It forms a sharp angle alpha with the horizontal line, respectively the rotational axis 301 of the wheels 300, 300′.

The wheel surface 303, 304 which runs on the running tread 400 is, in this case, designed like a cone or are truncated cone.

The advantage of the invention becomes evident in particular in the triangle of forces 170, 180, 190.

The weight 190 of the good 100 is orientated vertically. The normal force 180 is vertically to the running tread 400 and is, because of the inclination of the running tread (see angle alpha) larger than the weight 190. The pallet 101, respectively the good 100, tries to evade to the right hand side, this is shown with the horizontal force 170′.

In the same way a triangle of forces is formed on the right wheel, only with the difference that the normal line here is arranged rectangular to the running tread 400 and the horizontal power 170 arising from that acts to the left, opposite the horizontal power 170′ of the left hand wheel.

Therefore an equilibrium of forces is formed which eventually leads to a guide of the good between the rows 210, 220 of wheels and therefore results in a better centralisation of the run of the pallet. However, in case it happens nevertheless that the pallet rises at the side—this should be carried out against the respective weight—this movement is eventually limited by a wheel flange 330 which is arranged on the wheels on the outside.

The arrangement of the wheels 300, 300′ is, in the example shown, chosen in such a way that the cones which taper are orientated towards each other.

The running treads 400, 400′ are parts of the planes 401, 401′. The planes 401, 401′ intersect one another below the good 100. The invention, however, can also be realised in such a way that these planes intersect one another above the good 100.

By means of the dimension of the cone angle alpha it is possible that the normal force between the wheels and the pallet is increased and allows higher drive forces to be transmitted frictional engaged.

In FIG. 7 another variant of the invention is shown. The embodiment according to FIG. 6 shows a common wheel shaft 311 for the left and right hand wheel 300, 300′, however, here the arrangement is different. The rotational axes 301, 301′ of the wheels 300, 300′ are inclined with regard to the horizontal line. The wheels 300, 300′ are designed like cylinders, the rotational axis 301, 301′ is parallel to the inclination of the running treads 400, 400′.

As the rotational axes 301, 301′ are twisted to each other, an independent drive 600, 600′ is provided for the right and left hand row 210, 220 of wheels.

The embodiment according to FIG. 6 conveys the good 100 via the running treads 400, 400′. In the example shown in FIG. 7 the good 100 is located between the rows 310, 320 of wheels, the space in between is actually empty. The arrangement here is chosen in such a way that the work piece 110 is conveyed below the pallet 101 suspended on the pallet. The invention is basically suitable to convey the good upright as well as suspended.

Basically it is also possible to arrange the wheels 300, 300′ not horizontally side by side, but even diagonally or one above the other, and to pass the good 100 here accordingly.

The embodiment of the suspension of the wheel 300 is, by the way, chosen in such a way that the rotational axis 301 can move. In a variant of the invention it is provided that the wheel 300 and thus also its rotational axis 301 can swivel around a rotational axis 350, which is arranged vertically to the paper plane. Therefore the effect is that—in case a force engages according to arrow 360 vertically on the wheel housing 380—the wheel tries to evade along the circular movement 370 and thus removes the wheel 300 from the running tread 400. However, it is possible to disengage the drive wheel 300 from the running tread 400 and to deposit the good 100, if necessary, on a support.

The advantage of the arrangements of the drive 600 according to FIG. 7 is in particular the fact that the drive shaft 601, which can drive a number of wheels 300, is arranged as remote as possible from the work piece 110. As a rule the work piece 110 is the one to be machined on. If the drive lane is arranged near the work piece 110 the drive shaft 601 will obstruct the machining, respectively the free access. The chosen arrangement is clever in so far as the drive lane which extends along the complete conveying path and thus also through the machine tools is arranged as remote as possible from the work piece 110. The arrangement also operates safely, as chips and so on cannot appear there.

In FIG. 8 an arrangement of the conveying system according to the invention is shown, which has elements according to FIG. 6 as well as elements according to FIG. 7. The rotational axes 301, 301′ of the wheels 300 are orientated horizontally (as in FIG. 6). However, the wheels 300, 300′ do not have a common wheel shaft (as in FIG. 7). Again a drive lane 600, 600′ is provided on each of the rows 210, 220 of wheels. The good which has to be conveyed, here a work piece 110, is located suspended below the wheels 300, 300′. The pallet 101 with the running treads 400 is supported on the wheels 300, 300′. The good 100 extends between the rows 210, 220 of the wheels.

The wheel 300 shown here has a specially designed wheel surface 303. A crowned cone 390 has been chosen. The crowned cone 390 increases the plane pressure between the pallet and the wheel, reducing clearly the risk of floating of the pallet, as the forming of a greasing wedge disturbing the traction between the wheel and pallet is considerably more difficult.

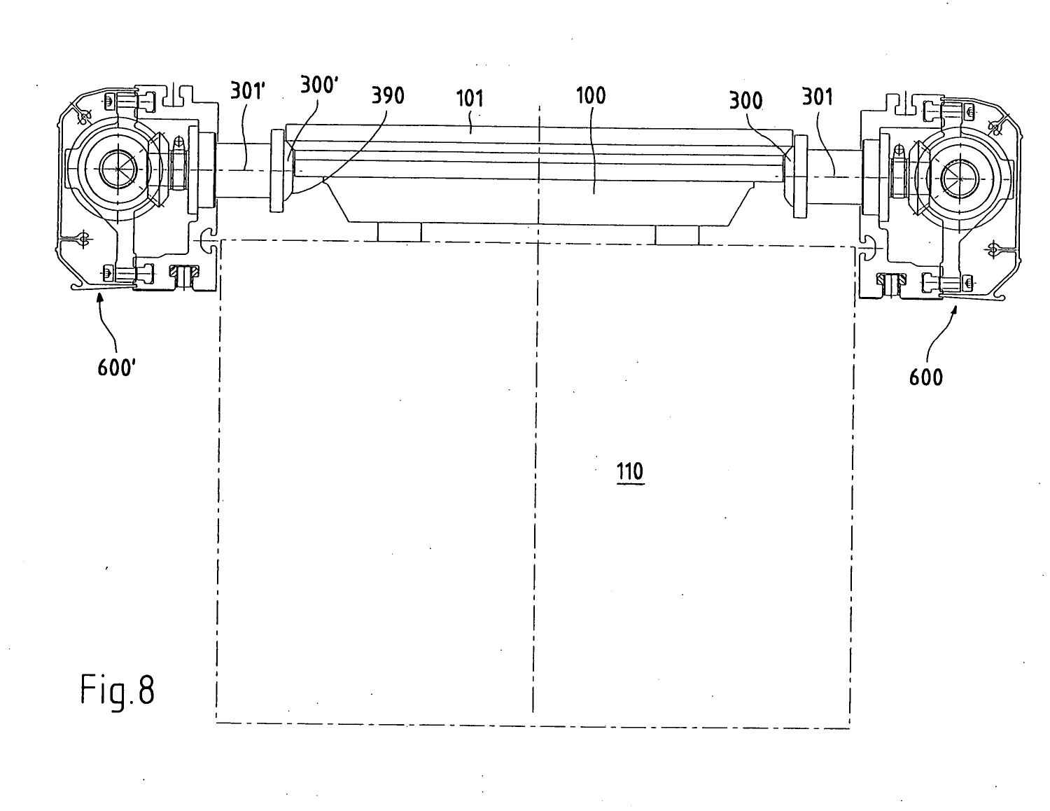

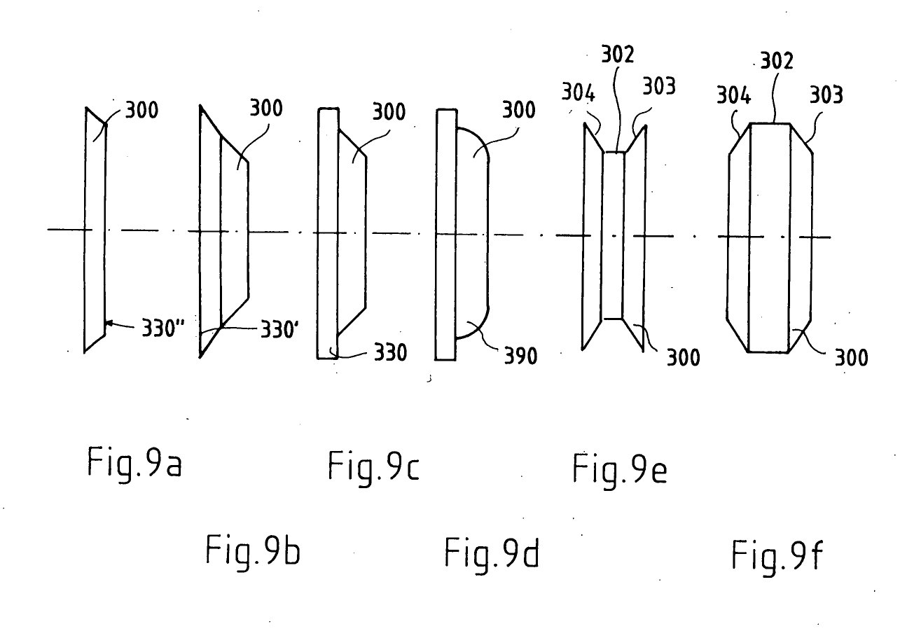

FIGS. 9a to 9d show various variants of the wheel 300.

In FIGS. 9a, 9b, 9c a cone-shaped wheel 300 is shown. The wheel surfaces 340 are shaped like truncated cones. In FIG. 9a the right hand plane of the wheel 300 acts as wheel flange 330″.

In FIG. 9b a conical wheel flange 330′ is provided. FIG. 9c shows a cylindrical wheel flange. FIG. 9d shows a crowned wheel 390, which may be used, for example, in FIG. 8.

Each of the variants according to the FIGS. 9a to 9d shows an embodiment of the wheel with a wheel surface like a truncated cone. The variants according to FIG. 9e, respectively 9f, have at least two wheel surfaces 304, 303.

The variant according to FIG. 9e shows a wheel 300 the wheel surface of which has a U- or V-shaped groove. The limbs of this groove indicate the differently inclined wheel surfaces. Also the cylinder-like surface 302 which connects the two wheel surfaces 303, 304 may also interact, if necessary, with the running tread of the good.

FIG. 9f shows furthermore the reversed principle according to FIG. 9e. Here two truncated cone-like wheels are put together in an opposite direction with a washer. The wheel surfaces 303, 304 intersect one another according to FIG. 9f outside the wheel 300, in FIG. 9e within the wheel 300.

The wheels according to FIG. 9e and FIG. 9f shown here do not have to be necessarily equipped with a wheel flange as the two surfaces themselves already result in a sufficient guide. Preferably the wheel surfaces 303, 304 are also designed crowned in order to reach a low-wear operation.

The variants shown according to FIGS. 9e and 9f are used in particular in a field of application as shown in FIG. 12.

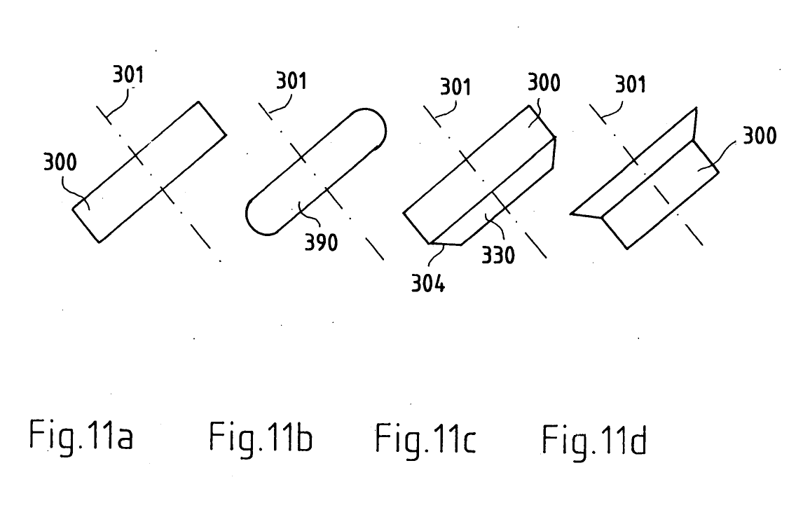

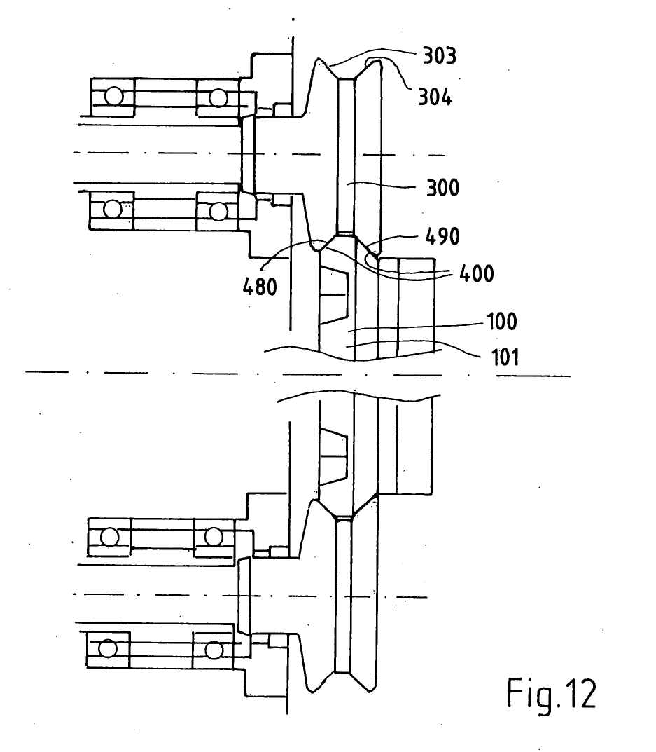

The wheel profiles shown in FIGS. 11a to 11d are provided in particular for a use as shown in FIG. 7.

In FIG. 11a simply a cylindrical wheel is provided.

FIG. 11b again shows a crowned wheel 390. FIGS. 11c and 11d show the use of a wheel flange 330, the variants according to FIGS. 11a, 11b do not show a wheel flange 330. The wheel flange may be arranged here on the inside, as shown in FIG. 11c, the wheel flange being here designed tampered and cone-like. The cone surface 303 then has, if necessary, also contact with the good. In contrast to that, the wheel flange 330 according to FIG. 11d is arranged on the outside, designed, if necessary cone-like, the cone expanding compared with the diameter of the wheel 300.

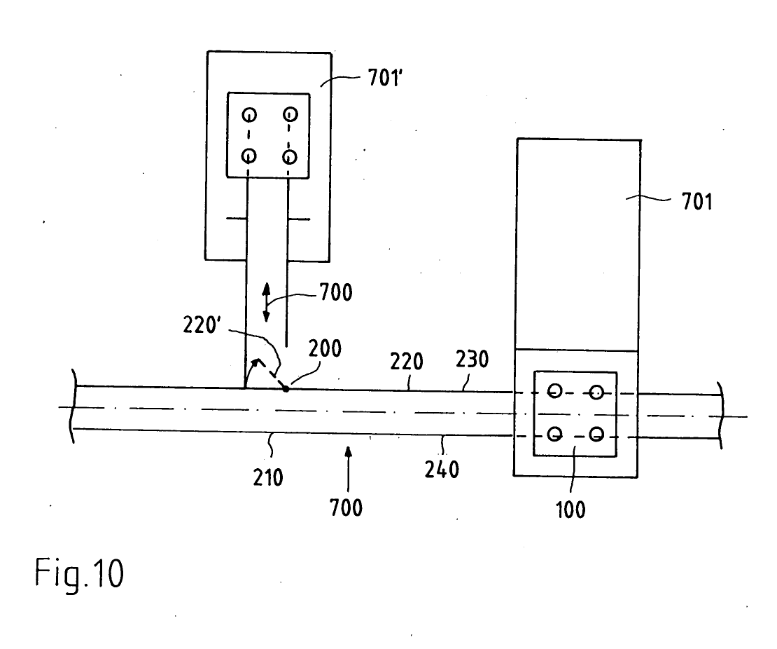

In FIG. 10 the use of a conveying system according to the invention is shown in an arrangement of machine tools 701, 701′ interlocked with each other. Machine tools 701 are provided which are arranged on the conveying path. However, there are also machine tools 701′ which are arranged rectangular to the conveying belt 200. In order to be able to convey the goods 100 also into these machine tools the good has to leave by the conveying belt 200.

As described the conveying belt 200 comprises two rows 210, 220 of wheels which have support profiles 230, 240 on which the wheels are supported. In the top support profile 230 a support profile part 230′ can be swivelled around a link 201, in order to enable the leaving, respectively the entering, of a good 100 from and into the machine tool 701′.

FIG. 12 shows the use of a special wheel 300, as it has been described, for example, in FIG. 9e. The concept according to the invention allows a conveying of the pallet 101, respectively of the good 100, even in an upright position. The rows of wheels are here arranged one above the other. The arrangement may also be carried out staggered one beside the other or horizontally one beside the other.

The edge of the pallet 101 has a first running tread 400, 490. This is basically arranged in the same way as the running tread in FIG. 6. The advantage of this variant is the fact that the actual region of the edge of the pallet is chamfered and thus the additional running tread 400, 480 is obtained. The pallet 101 presented here is thus suitable to be used in a standing operation as well as horizontally orientated as in FIG. 6. This arrangement according to the invention makes it possible to convey the good horizontally as well as vertically without re-clamping for example for testing purposes, that is a significant advantage.

The outer running tread 480 which is obtained by the chamfer interacts here with the wheel surface 303, the inner running tread 490 interacts with the wheel surface 304.

Although the invention has been described by exact examples which are illustrated in the most extensive detail, it is pointed that this serves only for illustration and that the invention is not necessarily limited to it, because alternative embodiments and methods become clear for experts in view of the disclosure. Accordingly changes can be considered which can be made without departing from the contents of the described invention.

1. Device for conveying goods, the device having two roller conveyors arranged one beside the other, on which the good, which has to be conveyed, is supported, characterised in that only one roller conveyor (1) has a drive (6) at least for a part of these rollers (4).

2. Device according to claim 1, characterised in that the roller conveyor (1) is provided in a frame (5), and the roller (4) of the roller conveyor (1) is supported in the frame (5).

3. Device according to claim 1, characterised in that the roller conveyor (1) is provided in a frame (5), and the roller (4) of the roller conveyor (1) is supported in the frame (5), and the roller (4) projects on the frame (5) on one side with a free collar, and the roller shaft (10) is supported in the frame (5).

4. Device according to claim 1, characterised in that the good (3) is located during conveying between the two roller conveyors (1, 2).

5. Device according to claim 1, characterized in that the good (3) is located during conveying between the two roller conveyors (1, 2), and the rollers (4) of the roller conveyors (1, 2) serve for guiding the good (3).

6. Device according to claim 1, characterized in that the good (3) is located during conveying between the two roller conveyors (1, 2), and the rollers (4) of the roller conveyors (1, 2) serve for guiding the good (3), and the roller (4) has at least on one side a flange with a side wall facing the good (3) against which the good (3), respectively a part of the good, can run.

7. Device according to claim 1, characterized in that the roller (4) has running treads which are inclined in the shape of a V or U.

8. Device according to claim 1, characterised in that the rollers (4) have running treads which are inclined in the shape of a V or U and that the running treads (46, 47) are designed inclined, plane or crowned.

9. Device according to claim 1, characterized in that the roller (4) has a circumferential groove (40) with side walls (41, 42) against which the good (3), respectively a part of the good, can run.

10. Device according to claim 1, characterised in that the roller (4) has a circumferential groove (40) with side walls (41, 42) against which the good (3), respectively a part of the good, can run, and the circumferential groove (40) is formed essentially U-shaped.

11. Device according to claim 1, characterised in that the roller (4) has a circumferential groove (40) with side walls (41, 42) against which the good (3), respectively a part of the good, can run, and the circumferential groove (40) is designed essentially U-shaped and the bottom (43) of the circumferential groove (40) is the running tread for the good (3), respectively the pallet carrying the good.

12. Device according to claim 1, characterized in that the roller (4) has a circumferential groove (40) with side walls (41, 42) against which the good (3), respectively a part of the good, can run, and the side wall (41, 42) is bevelled with regard to the bottom (43) of the groove and the circumferential groove (40), respectively the flange.

13. Device according to claim 1, characterised in that the roller (4) has a circumferential groove (40) with side walls (41, 42) against which the good (3), respectively a part of the good, can run, and the side wall (41, 42) is bevelled with regard to the bottom (43) of the groove and the circumferential groove (40), respectively the flange and the side wall (41, 42) is angled in itself.

14. Device according to claim 1 characterised in that the roller (4) has a circumferential groove (40) with side walls (41, 42) against which the good (3), respectively a part of the good, can run, and the circumferential groove (40) is formed essentially U-shaped and the bottom (43) of the circumferential groove (40) forms the running tread for the good (3), respectively the pallet carrying the good, and the bottom (43) of the groove is designed wider than the conveying rail (31) of the good (3) supported in the bottom (43) of the groove.

15. Device according to claim 1, characterised in that the roller (4) has running treads which are inclined V- or U-shaped, and the running treads of the roller (4) are essentially orientated horizontally, inclined, groove-like or V-like projecting.

16. Device according to claim 1, characterised in that the rollers (4) of the driven roller conveyor (1) and the rollers (4) of the not-driven roller conveyor (2) are designed in the same way.

17. Device according to claim 1, characterised in that the roller conveyor (1) is provided in a frame (5), and the roller (4) of the roller conveyor (1) is supported in the frame, and the frame (5) is designed like a housing, in particular with a housing lid (51) sealing the housing (50).

18. Device according to claim 1, characterised in that the roller conveyor (1) is provided in a frame (5), and the roller (4) of the roller conveyor (1) is supported in the frame, and the frame (5) is designed like a housing, in particular with a housing lid (51) sealing the housing (50), and the housing (50) holds the shaft drive (6) of the roller shaft (10).

19. Device according to claim 1, characterised in that the roller conveyor (1) is provided in a frame (5), and the roller (4) of the roller conveyor (1) is supported in the frame, and the frame (5) is designed like a housing, in particular with a housing lid (51) sealing the housing (50), and the housing (50) holds the shaft drive (6) of the roller shaft (10), and a gearwheel chain drive, an electric drive or a bevel gear drive is provided as shaft drive (6).

20. Device according to claim 1, characterised in that the roller conveyor (1) is provided in a frame (5), and the roller (4) of the roller conveyor (1) is supported in the frame, and the frame (5) is designed like a housing, in particular with a housing lid (51) sealing the housing (50), and the housing (5) can optionally also hold different types of shaft drives.

21. Conveying system, comprising a device for conveying goods according to claim 1, which conveys the good, in particular a pallet, and for conveying goods, for example work pieces or pallets, which carry work pieces, the good running on a conveyor belt, the good having at least two running treads, and the conveyor belt having at least one row of wheels, respectively rollers, the running tread running on the wheels, respectively rollers.

22. Conveying system according to claim 21, characterised in that at least one conveying rail (31) of the good (3) is provided which is supported on the on the bottom (43) of the groove of a roller equipped with a circumferential groove (40).

23. Conveying system according to claim 21, characterised in that two conveying rails of the good (3) are provided which are inclined towards each other, and which are supported on inclined running treads of a roller.

24. Conveying system according to claim 21, characterised in that the running treads (400) are designed either inclined or spherically.

25. Conveying system according to claim 21, characterised in that the planes (401) containing the running treads (400) intersect one another.

26. Conveying system according to claim 21, characterised in that the planes (401) containing the running treads (400) intersect one another and the planes (401) cut one another in a region between the wheel rows (210, 220).

27. Conveying system according to claim 21, characterized in that the planes (401) containing the running treads (400) intersect one another and the planes (401) intersect one another in a region between the wheel rows (210, 220) and the planes (401) intersect one another above or below the rotational axis (301) of the wheel (300, 300′) of the good (100).

28. Conveying system according to claim 21, characterised in that the running treads (400) are designed groove-like.

29. Conveying system according to claim 21, characterised by a supporting profile (230, 240) for the wheels (300).

30. Conveying system according to claim 21, characterised in that a supporting profile (230, 240) is provided for the wheels (300) and a part (230′) of the supporting profile can be swivelled around a joint (201).

31. Conveying system according to claim 21, characterized in that the running tread (400) of the good (100) is supported by the wheels (300).

32. Conveying system according to claim 21, characterized in that only one wheel row (210) has a drive (600), in particular a drive shaft (601) driving several wheels (300).

33. Conveying system according to claim 21, characterised in that both or more wheel rows have a common central drive or several drives.

34. Conveying system according to claim 21, characterized in that the rows of wheels (210, 220) are arranged one beside the other, above the other or staggered to each other.

35. Conveying system according to claim 21, characterised in that only one row of wheels (210) has a drive (600), in particular a drive shaft (601) driving several wheels (300), and both or more rows of wheels have a common central drive or several drives, and the wheel rows (210, 220) are arranged one beside the other, above the other or staggered to each other, and by a drive (600), preferably a friction drive of the wheels (300).

36. Conveying system according to claim 21, characterised in that the rotational axis (301) of the wheels (300) is inclined.

37. Conveying system according to claim 21, characterised in that two wheel rows (210, 220) are provided, and the wheels (300) of the two rows (210, 220) have a common axis and a common shaft and are each parallel to one another.

38. Conveying system according to claim 21, characterised in that two rows (210, 220) are provided, and the wheels of the two rows (210, 220) have a common axis or a common shaft and are each parallel to one another.

39. Conveying system according to claim 21, characterised in that two rows (210, 220) of wheels are provided and the wheels of the two rows (210, 220) have a common axis or a common shaft or each are parallel to one another.

40. Conveying system according to claim 21, characterised in that two rows (210, 220) of wheels are provided and the wheels of the two rows (210, 220) have a common axis and a common shaft or each are parallel to one another.

41. Conveying system according to claim 21, characterized in that the good (100) which has to be conveyed extends between the wheel rows (210, 220).

42. Conveying system according to claim 21, characterized in that the wheel (300) is formed cylinder-like.

43. Conveying system according to claim 21, characterised in that the wheel (300) is formed cone-like, respectively truncated cone-like.

44. Conveying system according to claim 21, characterized in that the wheel (300) has several differently inclined wheel surfaces (303, 304), and at least two wheel surfaces of the wheel interact with the running treads (400) of the good.

45. Conveying system according to claim 21, characterized in that the wheel (300) has several differently inclined wheel surfaces (303, 304), and at least two wheel surfaces of the wheel interact with the running treads (400) of the good, and the wheel surfaces are designed groove-shaped, essentially U-shaped, V-shaped or wedge-like.

46. Conveying system according to claim 21, characterized in that the wheel (300) has several differently inclined wheel surfaces (303, 304), and at least two wheel surfaces of the wheel interact with the running treads (400) of the good, and the wheel surface (303, 304) which runs on the running tread (400) is designed groove-like, wedge-like or double truncated cone-like, and the running tread (400) is designed crowned.

47. Conveying system according to claim 21, characterized in that the wheel (300) has several differently inclined wheel surfaces (303, 304), and at least two wheel surfaces of the wheel interact with the running treads (400) of the good, and the wheel surface (303, 304) which runs on the running tread (400) is designed groove-like, wedge-shaped or double truncated cone-like, or the running tread (400) is designed crowned.

48. Conveying system according to claim 21, characterised in that on the wheel (300) a wheel flange (330) is provided.

49. Conveying system according to claim 21, characterized in that the wheel (300) can be swivelled around an axis (350) which is rectangular to the rotational axis (301) of the wheel (300).

50. Conveying system according to claim 21, characterized by two wheel rows (210 and 220) and a different wheel gauge of the wheel rows (210, 220) along the conveyor belt.

51. Conveying system according to claim 21, characterised in that the good is conveyed by the conveyor belt either essentially vertically standing or diagonally at any angle or essentially horizontally orientated.

52. Good, in particular pallet with running treads which interact with rollers (4) of a device, respectively wheels (300) of a conveying device.

53. Good according to claim 52, characterized in that conveying rails (31) are provided on the good, respectively the pallet, which are supported by the running treads(s) of a roller.

54. Good according to claim 52, characterised in that conveying rails (31) are provided on the good, respectively the pallet, which are supported on the running tread(s) of a roller, and at least one lateral edge of the conveying rail (31) is bevelled or chamfered.

55. Good according to claim 52, characterized in that the conveying rails (31) are provided on the good, respectively the pallet, which are supported by the running tread(s) of a roller, and a groove is provided on the good beside the conveying rail (31) with a width selected so that only the side (32) provided on the conveying rail (31) and limiting the groove can interact with the roller (4).

56. Good according to claim 52, characterised in that the running treads are designed either inclined or spherically.

57. Good according to claim 52, characterized in that the running treads are designed either inclined or spherically, and the running treads are on one side of the good.

58. Good according to claim 52, characterised in that the running treads are designed either inclined or spherically, and the good, in particular the pallet, is chamfered in the region of the running tread, and the chamfering forms a running tread.

59. Good according to claim 52, characterised in that the running treads are designed either inclined or spherically, and the good, in particular the pallet, is chamfered in the region of the running tread, and these regions of the running tread interact either with groove-like, essentially U- or V-shaped designed wheel surfaces, or that cylinder-like or truncated cone-like wheels are arranged alternating which interact with the two adjoining regions of the running treads of the good.
